(19) United States
(12) Patent Application Publication
(10) Pub. No.: US 2022/0139386 A1
(43) Pub. Date: May 5, 2022

(54) SYSTEM AND METHOD FOR CHINESE PUNCTUATION RESTORATION USING SUB-CHARACTER INFORMATION

(71) Applicants: Beijing Wodong Tianjun Information Tehnology Co., Ltd., Beijing (CN); JD.com American Technologies Corporation, Mountain View, CA (US)

(72) Inventors: Min Li, Mountain View, CA (US); Shizhu Liu, Mountain View, CA (US); Gang He, Mountain View, CA (US); Hui Zhou, Sunnyvale, CA (US)

(21) Appl. No.: 17/087,991

(22) Filed: Nov. 3, 2020

(51) Int. Cl. G10L 15/19; G10L 15/16; G10L 15/00

(52) U.S. Cl. CPC G10L 15/19; G10L 15/005; G10L 15/16

(57) ABSTRACT

A system and a method for predicting punctuations for a text. The text is in a logographic language having characters. Most of the characters contain sub-characters representing meaning of the characters. The text lacks punctuations. The method includes receiving the text; providing a sub-character encoding based on a sub-character input editor (IME), such that each character in the logographic language corresponds to a specific sub-character code; encoding the text using the sub-characters encoding to obtain sub-character codes; generating sentence pieces from the sub-character codes; representing the sentence pieces by sentence piece vectors; and subjecting the vectors of the sentence pieces to a neural network to obtain the punctuations for the text. The method may be implemented using a computing device.

### CROSS-REFERENCES

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present disclosure relates generally to the field of punctuation restoration, and more particularly to systems and methods for punctuation restoration for Chinese text using sub-character information of the Chinese characters.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the current social media and mobile era, text without punctuation is commonly seen. For example, auto speech recognition (ASR) is a common technique used by computing devices to recognize speeches. Spoken audio may be communicated via mobile applications, or left as phone messages, and ASR can translate the spoken audio into text. However, the translated text is generally without punctuation. In another example, social media including messengers and microblogs contain informal text, and those text often miss punctuation marks. Text without punctuation marks has poor readability and causes bad user experiences. Moreover, the performance of downstream applications suffers.

In addition, in e-commerce scenario, text in user generated content are usually informally written. Such text contains a large amount of web trending words, jargon and lingo associated with domain names, and emoji et al. Restoring punctuation on informal written text is even more challenging, because of the difficulty incurred by these open vocabulary issues.

A plethora number of studies utilizes language models, hidden Markov chains, conditional random fields (CRFs) and neural networks with lexical and acoustic features and word or character level representations to predict punctuation. These approaches with word level or character level models fall short in handling out-of-vocabulary (OOV) problem since they fail to provide word representation of the characters or words that are out of vocabulary.

Therefore, for punctuation prediction of a text, occurrence of a rare word or an OOV word may cause prediction inaccuracy, and an unaddressed need exists in the art to address the aforementioned deficiencies and inadequacies.

### SUMMARY

In certain aspects, the present disclosure relates to a method for predicting punctuations for a text. The text is in a logographic language having a plurality of characters, at least one of the characters includes a plurality of sub-characters representing meaning of the at least one character, and the text lacks punctuations. In certain embodiments, the length of the text corresponds to a small paragraph or several sentences. In certain embodiments, the text includes more than five words. In certain embodiments, the text includes more than 10 words. In certain embodiments, the text includes more than 15 words. In certain embodiments, the text includes less than 500 words. In certain embodiments, the text includes less than 100 words. In certain embodiments, the method includes: receiving the text; providing, by a computing device, a sub-character encoding based on a sub-character editor (or input method, or input method editor abbreviated as IME), such that each character in the logographic language corresponds to a specific sub-character code; encoding, by the computing device, the text using the sub-characters encoding to obtain sub-character codes; generating, by the computing device, sentence pieces from the sub-character codes; representing, by the computing device, the sentence pieces by sentence piece vectors; and subjecting, by the computing device, the vectors of the sentence pieces to a neural network to obtain the punctuations for the text.

In certain embodiments, the language is Chinese, the characters are Chinese characters, and the IME is Wubi or Stroke.

In certain embodiments, the step of generating the sentence pieces is performed using byte pair encoding.

In certain embodiments, the step of representing the sentence pieces by vectors is performed using word2vec. In certain embodiments, the word2vec is performed using skip-gram or continuous bag of words. In certain embodiments, word2vec is trained by: providing a plurality of training text; encoding the training text using the sub-character encoding to obtain training sub-character codes; generating a vocabulary of sentence pieces from the training sub-character codes based on a predefined sentence piece number; and representing the vocabulary of sentence pieces by sentence piece vectors based on context of the training text. In certain embodiments, the language is Chinese, the number of the characters is in a range of 6,000 to 7,000, and the predefined sentence piece number is in a range of 20,000 to 100,000. In certain embodiments, the predefined sentence piece number is about 50,000.

In certain embodiments, the neural network is pretrained by: providing a plurality of training text having punctuations; encoding the training text using the sub-character encoding to obtain training sub-character codes; generating training sentence pieces from the training sub-character codes; representing the training sentence pieces by sentence piece vectors; labeling the training text using the punctuations to obtain punctuation labels; generating predicted punctuation using the sentence piece vectors using the neural network; and comparing the predicted punctuations with the punctuation labels to train the neural network.

In certain embodiments, the neural network is a bidirectional long short-term memory (BiLSTM). In certain embodiments, the BiLSTM includes a multi-head attention layer.

In certain embodiments, the method further includes: receiving the text lacking punctuations by extracting the text from an e-commerce website; after obtaining the punctuations for the text from the trained neural network models, inserting the punctuations to the text to obtain text with punctuations; and replacing the text lacking punctuations with the text with punctuations on the e-commerce web site.

In certain embodiments, the method further includes: extracting audio from a video; processing the audio using audio speech recognition (ASR) to obtain the text; after obtaining the punctuations for the text from the trained neural network models, inserting the punctuations to the text lacking punctuations to obtain text with punctuations; and adding the text with punctuations to the video. The added text with punctuations may be subtitle of the video.

In certain aspects, the present disclosure relates to a non-transitory computer readable medium storing computer executable code. In certain embodiments, the computer executable code, when executed at a processor of a computing device, is configured to perform the method described above.

In certain aspects, the present disclosure relates to a system for predicting punctuations for a text. The text is in a logographic language having a plurality of characters, at least one of the characters includes a plurality of sub-characters representing meaning of the at least one character, and the text lacks punctuations. The system includes a computing device, the computing device has a processor and a storage device storing computer executable code, and the computer executable code, when executed at the processor, is configured to: receive the text; provide a sub-character encoding based on a sub-character input editor (IME), such that each character in the logographic language corresponds a specific sub-character code; encode the text using the sub-character encoding to obtain sub-character codes; generate sentence pieces from the sub-character codes; represent the sentence pieces by sentence piece vectors; and subject the sentence piece vectors to a neural network to obtain the punctuations for the text.

In certain embodiments, the language is Chinese, and the characters are Chinese characters; the IME is Wubi or Stroke; and the computer executable code is configured to generate the sentence pieces using byte pair encoding, and represent the sentence pieces using word2vec. In certain embodiments, the neural network is a bidirectional long short-term memory (BiLSTM).

In certain embodiments, the word2vec is trained by: providing a plurality of training text; encoding the training text using the sub-character encoding to obtain training sub-character codes; generating a vocabulary of sentence pieces from the training sub-character codes based on a predefined sentence piece number; and representing the vocabulary of sentence pieces by sentence piece vectors based on context of the training text. In certain embodiments, the language is Chinese, the number of the characters is in a range of 6,000 to 7,000, and the predefined sentence piece number is in a range of 20,000 to 100,000. In certain embodiments, the predefined sentence piece number is about 50,000.

In certain embodiments, the neural network is pretrained by: providing a plurality of training text having punctuations; encoding the training text using the sub-character encoding to obtain training sub-character codes; generating training sentence pieces from the training sub-character codes; representing the training sentence pieces by sentence piece vectors; labeling the training text using the punctuations to obtain punctuation labels; generating predicted punctuation by the neural network using the sentence piece vectors; and comparing the predicted punctuations with the punctuation labels to train the neural network. In certain embodiments, the neural network is a bidirectional long short-term memory (BiLSTM).

Such technique helps solve the rare word and out of vocabulary problem. Moreover, the method encodes the similarities between characters, builds powerful and more robust neural network model, and obtains comparable expressivity with much fewer parameters with sub-character information.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings. These accompanying drawings illustrate one or more embodiments of the present disclosure and, together with the written description, serve to explain the principles of the present disclosure. Wherever possible, the same reference numbers are used throughout the drawings to refer to the same or like elements of an embodiment, and wherein:

FIG. 1 schematically depicts a system for punctuation restoration according to certain embodiments of the present disclosure.

FIG. 2 schematically depicts training of vector representation of sentence pieces according to certain embodiments of the present disclosure.

FIG. 3 schematically depicts training of punctuation prediction neural network according to certain embodiments of the present disclosure.

FIG. 4 schematically depicts punctuation restoration according to certain embodiments of the present disclosure.

FIG. 5 schematically depicts paragraphs of text, their Wubi encoding, and their sentence pieces according to certain embodiments of the present disclosure.

FIG. 6 schematically depicts paragraphs of text, their Stroke encoding, and their sentence pieces according to certain embodiments of the present disclosure.

FIG. 7 schematically depicts generating punctuation labels for paragraphs of text paragraphs according to certain embodiments of the present disclosure.

FIG. 8 schematically depicts a bidirectional long short-term memory (BiLSTM) model for predicting punctuations from sentence pieces according to certain embodiments of the present disclosure.

FIG. 9 schematically depicts an improved BiLSTM model for predicting punctuations from sentence pieces according to certain embodiments of the present disclosure.

FIG. 10 schematically depicts a method for training vector representation of sentence pieces according to certain embodiments of the present disclosure.

FIG. 11 schematically depicts a method for training punctuation prediction neural network according to certain embodiments of the present disclosure.

FIG. 12 schematically depicts a method for punctuation restoration according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” or “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module or unit may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

In certain aspects, the present disclosure combines sub-character information with sentence piece algorithm to solve the rare word or 00V problem to increase punctuation prediction accuracy. Further, using sentence pieces consisting of sub-characters, the computation overhead is significantly reduced by decreasing the number of encoded sequences corresponding to the text. Moreover, the disclosure encodes the similarities between characters, builds powerful and more robust language model, and obtains comparable expressivity with much fewer parameters with sub-character information.

The disclosure creatively combines sub-character into sentence pieces for punctuation restoration. The sub-character information exists in several logographic languages, such as Chinese, Egyptian hieroglyphs, Maya glyphs, and their derivatives. In Chinese, the sub-character information of Chinese characters can contain either strokes or radicals of a character. The stroke is a movement of a writing instrument on a writing surface, and each character has a stroke order containing sequentially multiple strokes. A radical includes one or several strokes. The radicals of a character usually represent smallest semantic unit, and different characters may share the same radical. For example, the radical ‘ [symbol] ’ typically is related to personal emotions and psychological status. Characters containing the radical “ [symbol] ” include, for example, “ [symbol] ” (sorrow), “ [symbol] ” (hate), “ [symbol] ” (fear), “ [symbol] ” (regret), “ [symbol] ” (memory). The radical ‘ [symbol] ’ is related to human bodies when it is located at the left or bottom corner of the character, such as in the characters “ [symbol] ” (face), “ [symbol] ” (liver), “ [symbol] ” (chest), “ [symbol] ” (buttocks), while it is related to time when located at the right corner of a character, such as in the character “ [symbol] ” (period). The radical ‘ [symbol] ’ is related to hands and arms of a human body and characters containing the radical ‘ [symbol] ’ are typically verbs. When the model of the present disclosure learns that the words or characters containing the radical ‘ [symbol] ’ are used as verbs, the model is less likely to place those characters at the end of a sentence. The system of the disclosure also utilizes sentence piece algorithm to automatically build a customized vocabulary for the targeted system. After building the vocabulary, the disclosure further trains vector representation of the vocabulary with methods such as continuous bag of word or skip gram. The vector representation then serves as the input of the neural network model trained to predict punctuation marks.

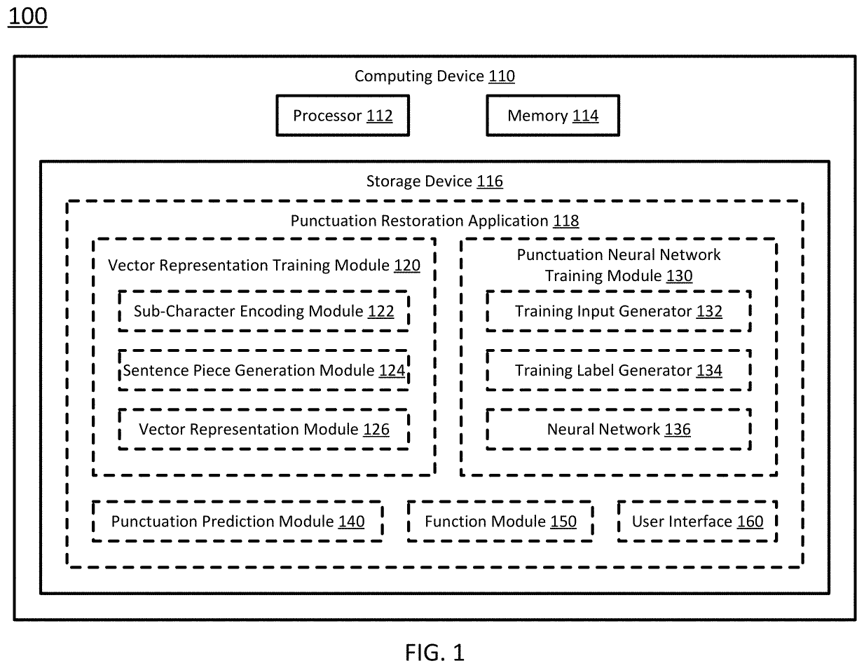

In certain aspects, the present disclosure provides a system and a method for predicting punctuations of a text based on sub-character information. FIG. 1 schematically depicts a system for punctuation prediction according to certain embodiments of the present disclosure. As shown in FIG. 1, the system 100 includes a computing device 110. In certain embodiments, the computing device 110 may be a server computer, a cluster, a cloud computer, a general-purpose computer, a headless computer, or a specialized computer, which makes punctuation prediction. The computing device 110 may include, without being limited to, a processor 112, a memory 114, and a storage device 116. In certain embodiments, the computing device 110 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices.

The processor 112 may be a central processing unit (CPU) which is configured to control operation of the computing device 110. In certain embodiments, the processor 112 can execute an operating system (OS) or other applications of the computing device 110. In certain embodiments, the computing device 110 may have more than one CPU as the processor, such as two CPUs, four CPUs, eight CPUs, or any suitable number of CPUs. The memory 114 may be a volatile memory, such as the random-access memory (RAM), for storing the data and information during the operation of the computing device 110. In certain embodiments, the memory 114 may be a volatile memory array. In certain embodiments, the computing device 110 may run on more than one processor 112 and/or more than one memory 114. The storage device 116 is a non-volatile data storage media or device. Examples of the storage device 116 may include flash memory, memory cards, USB drives, solid state drives, or other types of non-volatile storage devices such as hard drives, floppy disks, optical drives, or any other types of data storage devices. In certain embodiments, the computing device 110 may have more than one storage device 116. In certain embodiments, the computing device 110 may also include a remote storage device 116.

The storage device 116 stores computer executable code. The computer executable code includes a punctuation restoration application 118, and optionally input data for training and prediction of the punctuation restoration application 118. The punctuation restoration application 118 includes the code or instructions which, when executed at the processor 112, predicts or restores punctuation from a text, where the text lacks punctuation. In certain embodiments, the punctuation restoration application 118 may not be executable code, but in a form of circuit corresponding to the function of the executable code. By providing a circuit instead of executable code, the operation speed of the punctuation restoration application 118 118 is greatly improved. In certain embodiments, as shown in FIG. 1, the punctuation restoration application 118 includes, among other things, a vector representation training module 120, a punctuation neural network training module 130, a punctuation prediction module 140, a function module 150, and a user interface 170.

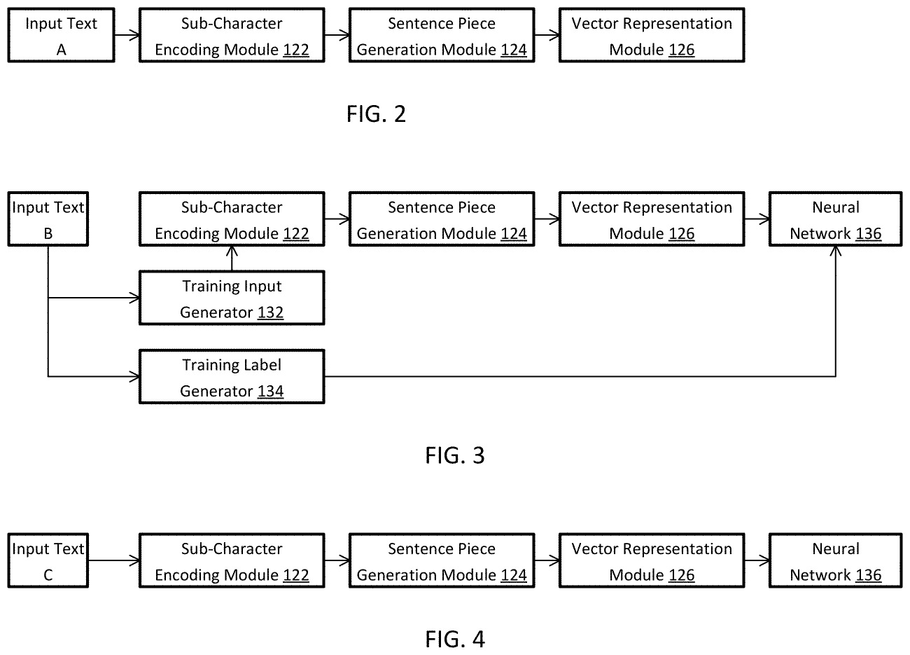

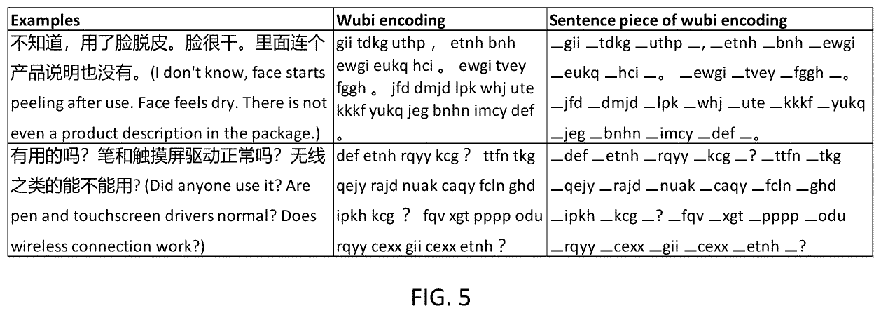

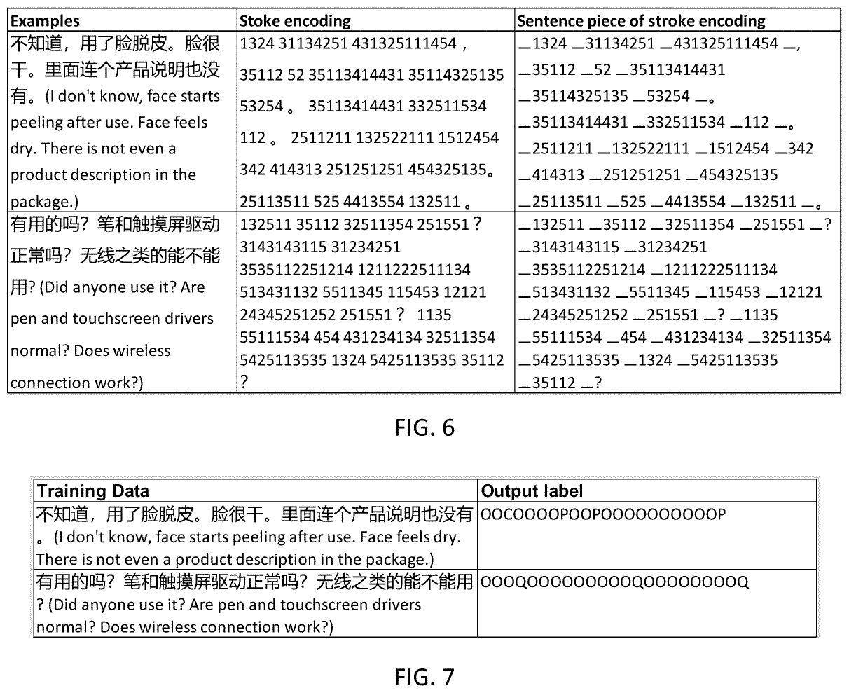

The vector representation training module 120 includes a sub-character encoding module 122, a sentence piece generation module 124 and a vector representation module 126, and is configured to train vector representation of an input text. FIG. 2 schematically depicts a flowchart of a training for vector representation which is used as the input of neural network according to certain embodiments of the present disclosure. As shown in FIG. 2, when input text A for vector representation training, such as Chinese sentences are provided, the sub-character encoding module 122 is configured to encode the input text A into sub-character encodings, and send the sub-character encodings to the sentence piece generation module 124. In certain embodiments, the sub-character encoding may be performed based on Wubi encoding, Stroke encoding, or any other type of encodings considering sub-characters of the characters. For an IME such as Wubi or Stroke, a keyboard combination may be used as input, the input corresponds to a code in the computing device, the code may correspond to several difference characters, and a user can select one of the different characters as the final input. In the Wubi or Stroke based encoding of the present disclosure, the above process is reversed. Specifically, for each character input, the sub-character encoding module 122 provides a code, and each character corresponds to one definite code. Because of the one character-one code correspondence, human interaction is not required. FIG. 5 shows Wubi encoding of two Chinese sentences according to certain embodiments of the present disclosure. For a sentence in the examples, there are corresponding Wubi encodings, where each character is encoded by its full Wubi code. As shown in FIG. 5, for the first three characters “ [symbol] ” (I don't know) in the first sentence, the corresponding full codes are “gii” “tdkg” and “uthp,” respectively. Kindly note the punctuations in the sentence are shown in the Wubi encoding in FIG. 5 so that the correspondence between the example characters and its Wubi encoding is obvious. However, the sub-character encoding module 122 may only encode the characters, and the punctuations in the Wubi encoding in FIG. 5 thus do not exist. Further, the space between the characters may be kept during the encoding by the sub-character encoding module 122. In certain embodiments, the spaces are encoded with the same special code. In certain embodiments, the sub-character encoding module 122 is configured to encode the input text using Stroke encoding. In Stroke encoding, each Chinese character includes one or more sequential strokes, the strokes are categorized into five types corresponding to the numbers 1, 2, 3, 4, and 5, and each Chinese character can then be represented by a sequential number consists of some of the five numbers. As shown in FIG. 6, the first Chinese character “ [symbol] ” includes four strokes, the four sequential strokes are type 1, type 3, type 2, and type 4 strokes. Therefore, the character has a Stroke encoding of “1324.”

The sentence piece generation module 124 is configured to, upon receiving the sub-character encodings, generate sentence pieces, and send the sentence pieces to the vector representation module 126. In certain embodiments, the sentence piece generation module 124 is configured to generate the sentence pieces using byte pair encoding. Specifically, the sub-character encoding is a continuous encoding without punctuations. For example, the Wubi encoding for the first sentence shown in FIG. 5 would be “gii tdkg uthp etnh bnh ewgi eukq hci ewgi tvey fggh jfd dmjd lpk whj ute kkkf yukq jeg bnhn imcy def” and the encoding is converted into sentence pieces. Depending on the parameters of the byte pair encoding, the separations between the sentence pieces may not fall between the characters. In other words, each unit of the sentence pieces may include Wubi encoding of one sub-character such as “the first sub-character of the character one;” a few sub-characters such as “the first and second sub-characters of the character one;” one character such as “the character one;” two or more adjacent characters such as “the characters one, two and three;” one or more characters and a sub-character such as “the character one, the character two and the first sub-character of the character three;” or one or more characters with one or more sub-characters, such as “the last sub-character of character one, the character two, and the first sub-character of the character three.” For example, for a sentence with three characters, character one has three sub-characters, character two has four sub-characters, and character three has four sub-characters. Then the possible sentence pieces may include, for example, encoding of: “sub-character one of character one,” “sub-character two of character one,” . . . , “sub-character four of character three,” “character one,” “character two,” “character three,” “character one-character two,” “character two-character three,” “character one-character two-character three,” “sub-character three of character one-character two-character three,” “character one-character two-sub-character one of character three,” and “sub-character three of character one-character two-sub-character one of character three.” In certain embodiments, the total number of generated sentence pieces is predefined, and the sentence pieces having high frequency of occurrence in the whole training datasets are picked as the sentence pieces. In certain embodiments, while Wubi defines about 6,000 to 7,000 Chinese characters, the disclosure may define the total number of generated sentence pieces in a range of 20,000 to 100,000, such as 50,000. In certain embodiments, the generated sentence pieces are collectively named a vocabulary for the punctuation restoration application 118. Kindly note that the vocabulary itself is not predefined, but is automatically generated by the sentence piece generation module 124. The sentence pieces in the vocabulary may include sub-characters, characters, combination of sub-characters, combination of characters, and combination of sub-character and characters. By sentence pieces generation, the information hidden in the sub-characters of the Chinese characters can be extracted and explained.

The vector representation module 126 is configured to, upon receiving the encoded, generated sentence pieces, train vector representation of the sentence pieces. The training of the vector representation module 126 requires a large number of input text data so that the distances between the vectors represent context relationship between the corresponding sentence pieces. In certain embodiments, the input text may be selected from data on a specific subject. For example, the input text related to a category of products in an e-commerce website may be retrieved to train the vector representation, and the well trained punctuation restoration application 118 may be used to predict punctuations for the text that relates to the category of products. In certain embodiments, a broad coverage of input text is selected to train the vector representation, so that the well trained punctuation restoration application 118 can be used under a variety of scenarios. In certain embodiments, the vector representation module 126 is a word2vec model, which may be trained using skip-gram or continuous bag of words (CBOW). In certain embodiments, dimensions of the vectors are in a range of about 50-1,000. In certain embodiments, the dimensions of the vectors are 300. After training, each sentence pieces in the vocabulary is represented by a vector, and the distances between the vectors indicate the relationship between the corresponding sentence pieces in the context. In certain embodiments, the vector representation is in a key-value format. In certain embodiments, since the sentence pieces and their vector representation correspond to each other one-to-one, both the collective sentence pieces and the collective vector representation may be called the vocabulary or dictionary of the sentence pieces.

In certain embodiments, varying the vocabulary size of the sentence pieces explores the trade off the computation efficiency and the capability to capture the similarity between different characters.

In certain embodiments, the punctuation restoration application 118 is configured to use glyph vector representation for the input text A instead of using the sub-character encoding module 122 and the sentence piece generation module 124. In certain embodiments, the punctuation restoration application 118 is configured to use the glyph vector representation in combination with the sub-character encoding.

The punctuation neural network training model 130 is configured to, when the vector representation training module 120 has completed the training of vector representation, train a punctuation neural network. Referring back to FIG. 1, the punctuation neural network training module 130 includes a training input generator 132, a training label generator 134, and a neural network 136. FIG. 3 schematically depicts a flowchart for training the neural network 136 according to certain embodiments of the present disclosure. As shown in FIG. 3, input text B for training punctuation prediction of the neural network 136 is provided. The input text B in FIG. 3 may be the same as or different from the input text A in FIG. 2. The input text B can be, for example, Chinese sentences. The training input generator 132 is configured to, when the input text B is available, instruct the sub-character encoding module 122 to encode the input text B to sub-character encodings (or sub-character codes), instruct the sentence piece generation module 124 to generate sentence pieces from the sub-character encoding, instruct the well-trained vector representation module 126 to provide vector representations of the generated sentence pieces, and send the vector representations to the neural network 136. The sentence piece generation module 124 is configured to generate sentence piece based on the sentence piece vocabulary constructed during the training of the vector representation module 126, and each sentence here may correspond to one set of sentence pieces that have a high occurrence in the vocabulary.

At the same time, the training label generator 134 is configured to automatically generate labels for the input text B, and send the labels to the neural network 136. In certain embodiments, the disclosure defines punctuation restoration as a sequence to sequence tagging problem. FIG. 7 schematically depicts generation of tagged labels from an input text. As shown in FIG. 7, when an input text, such as one or a few sentences are available, the training label generator 134 is configured to tag the characters (tokens) into a set of symbols. If a character is followed by another character, the character is tagged with the symbol “O,” if the character is followed by a punctuation mark, it is labeled based on the punctuation following the character. For example, if the character is followed by a question mark, the character is tagged as “Q,” if the character is followed by a period mark, the character is tagged as “P,” and if the character is followed by a comma, the character is tagged as “C.”

Referring back to FIG. 3, the neural network 136 is configured to, upon receiving the vector representation of the input text B from the vector representation module 126 and the corresponding labels from the training label generator 134, predict existence of punctuations from the vector representation of sentence pieces, compare the predicted punctuation marks and their locations with the labels, use a loss function to penalize wrong label predictions and encourage correct label predictions, and obtain a well trained neural network 136 after rounds of training using the input text B. Each round of training may be performed using certain number of sentences from the input text B, and the training using the certain number of sentences may be performed several times to achieve convergence.

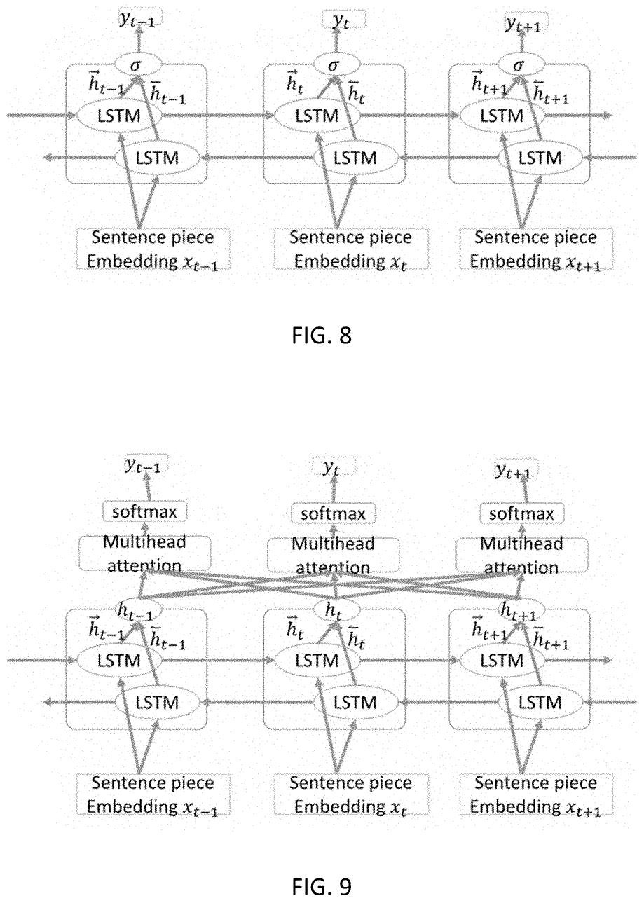

FIG. 8 schematically depicts an exemplary model structure of the neural network 136 according to certain embodiments of the present disclosure. As shown in FIG. 8, the neural network 136 is a bidirectional long short-term memory (BiLSTM). When a sequence of sentence pieces are available, the sentence piece vectors are inputted to the BiLSTM. In certain embodiments, the σ function uses softmax function to output the predicted labels. In certain embodiments, the LSTM components can be changed to other recurrent computation units such as gated recurrent units (GRUs). In certain embodiments, the LSTM layer can have multiple layers instead of just one layer. The multiple layers of LSTM may help capturing the syntactic and semantic information of the input text. However, it incurs more computation overhead.

FIG. 9 schematically depicts another exemplary model structure of the neural network 136 according to certain embodiments of the present disclosure. As shown in FIG. 9, the disclosure uses a Bi-LSTM recurrent network with multi-head attention followed by softmax functions. Attentions are known to be good at capturing the interactions between the sequences.

The punctuation prediction module 140 is configured to, after the well training of the neural network 136, predict punctuations for a input text. FIG. 4 schematically depicts a flowchart of punctuation prediction according to certain embodiments of the present disclosure. As shown in FIG. 4, input text C for punctuation prediction is provided. The input text C may be, for example, a paragraph of text containing several sentences. The length of the input text C may be, for example, in a range of from five characters to a few hundred characters. In certain embodiments, the input text C includes 10 to 50 characters. The punctuation prediction module 140 is configured to, when the input text C is available, instruct the sub-character encoding module 122 to encode the input text C to sub-character encoding (or sub-character codes), instruct the sentence piece generation module 124 to generate sentence pieces from the sub-character encoding, instruct the well-trained vector representation module 126 to provide vector representations of the generated sentence pieces, and instruct the well trained neural network 136 to predict punctuations from the sentence pieces. The generated sentence pieces are based on well trained sentence piece model. The punctuation prediction module 140 may be further configured to, after punctuation prediction by the neural network 136, add the predicted punctuation to the original input text C, so as to form a text C with punctuations.

The function module 150 may be stored in the computing device 110 or any other computing devices that are in communication with the computing device 110. The function module 150 is configured to perform certain functions applying the punctuation restoration application 118. In certain embodiments, the function is to predict punctuation for a social media message lacking punctuation, and the function module 150 is configured to instruct the sub-character encoding module 122 to encode the media message to sub-character encoding, instruct the sentence piece generation module 124 to generate sentence pieces from the sub-character encoding, instruct the well-trained vector representation module 126 to provide vector representations of the generated sentence pieces, and instruct the well trained neural network 136 to predict punctuations from the sentence pieces. The predicted punctuations can be added back to the media message, and the media message with punctuations can be displayed to the users or be stored for other applications.

In certain embodiments, the function is to predict punctuation for recognized text from an audio, where the recognized text does not include punctuations. The punctuations of the recognized text are predicted as described above, and the recognized text is added with the predicted punctuations. In certain embodiments, the recognized text is derived from a movie or video, the punctuations of the recognized text are predicted as described above and added to the recognized text, and the recognized text with predicted punctuations is added to the movie or video as subtitles.

In certain embodiments, the function is to add punctuations to a message inputted by a user in an e-commerce platform or a mobile phone, but the message does not include punctuation. The function may predict punctuations for the message, add the punctuations to the edited message, such that the user can confirm the correctness of the punctuations, and after confirmation, post the message on the e-commerce platform or send the mobile message out.

The user interface 160 is configured to provide a user interface or graphic user interface in the computing device 110. In certain embodiments, the user or the administrator of the system is able to configure parameters for the computing device 110, for example the size or the size range of the sentence pieces.

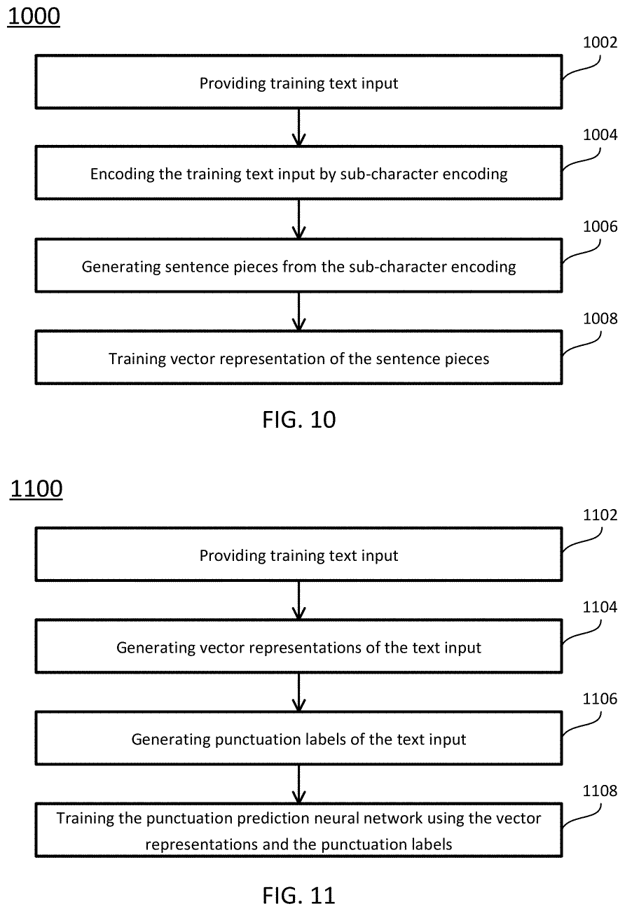

FIG. 10 schematically depicts a method for vector representation training according to certain embodiments of the present disclosure. In certain embodiments, the method 1000 as shown in FIG. 10 may be implemented on a computing device 110 as shown in FIG. 1. It should be particularly noted that, unless otherwise stated in the present disclosure, the steps of the method may be arranged in a different sequential order, and are thus not limited to the sequential order as shown in FIG. 10. In certain embodiments, the procedures shown in FIG. 10 correspond to the flowchart shown in FIG. 2.

At procedure 1002, the training input text is provided. The training text input includes a large number of text datasets. The text datasets are in a logographic language such as Chinese. Each text dataset may include one or more sentences and punctuations.

At procedure 1004, for each inputted text dataset, the sub-character encoding module 122 converts the text dataset into sub-character encodings, and sends the sub-character encodings to the sentence piece generation module 124. In certain embodiments, the datasets are in Chinese, and the sub-character encoding is Wubi or stroke.

At procedure 1006, upon receiving the sub-character encoding, the sentence piece generation module 124 generates sentence pieces from the encoding, and sends the generated sentence pieces to the vector representation module 126. In certain embodiments, the generation of the sentence pieces is performed using byte pair encoding. In certain embodiments, the sentence piece module 124 defines a size of the sentence piece vocabulary. In certain embodiments, the size is in a range of 20,000 to 100,000 for Chinese language. In certain embodiments, the size is about 50,000.

At procedure 1008, upon receiving the generated sentence pieces from the training datasets, the vector representation module 126 trains a vector representation of the generated pieces. In certain embodiments, the vector representation training is performed using skip-gram or continuous bag of words.

After well training of the vector representation, neural networks for predicting punctuations can be trained. FIG. 11 schematically depicts a method for training a punctuation prediction neural network according to certain embodiments of the present disclosure. In certain embodiments, the method 1100 as shown in FIG. 11 may be implemented on a computing device 110 as shown in FIG. 1. It should be particularly noted that, unless otherwise stated in the present disclosure, the steps of the method may be arranged in a different sequential order, and are thus not limited to the sequential order as shown in FIG. 11. In certain embodiments, the procedures shown in FIG. 11 correspond to the flowchart shown in FIG. 3.

At procedure 1102, the training input text is provided. The training input text includes a large number of text datasets. The text datasets are in a logographic language such as Chinese. Each text dataset may include one or more sentences and punctuations.

At procedure 1104, the training input generator 132 instructs the sub-character encoding module 122 to convert a text dataset into sub-character encoding, instructs the sentence piece generation module 124 to generate sentence pieces from the sub-character encoding, instructs the well-trained vector representation module 126 to retrieve corresponding vector representations of the generated sentences, and sends the vector representations to the neural network 136.

At procedure 1106, the training label generator 134 automatically create labels for the text datasets, and sends the labels to the neural network 136. In certain embodiments, for each of the characters in each of the text datasets, a specific character having a character following it is tagged with a same indicator indicating that the specific character is not before a punctuation mark, and another specific character having a punctuation following it is tagged with an indicator indicating the types of punctuation following the another specific character.

At procedure 1108, upon receiving the vector representations of the training text datasets and their corresponding punctuation labels, the neural network 136 predicts punctuations from the vector representations, compares the predicted punctuations with the labels, and updates its parameters based on the comparison. By rounds of training using the large amount of training datasets, the neural network 136 can be well-trained.

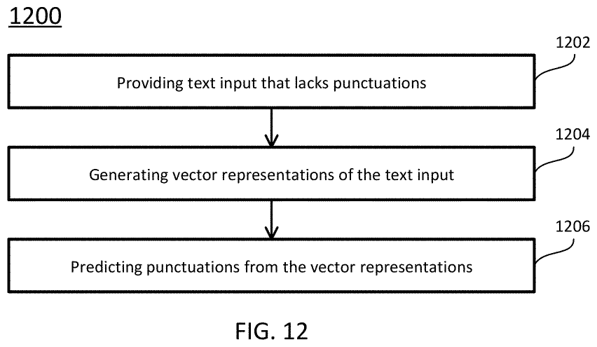

After well training of the punctuation prediction neural networks, the application of the present disclosure can be used to make punctuation predictions. FIG. 12 schematically depicts a method for predicting punctuation from a text input according to certain embodiments of the present disclosure. In certain embodiments, the method 1200 as shown in FIG. 12 may be implemented on a computing device 110 as shown in FIG. 1. It should be particularly noted that, unless otherwise stated in the present disclosure, the steps of the method may be arranged in a different sequential order, and are thus not limited to the sequential order as shown in FIG. 12. In certain embodiments, the procedures shown in FIG. 12 correspond to the flowchart shown in FIG. 4.

At procedure 1202, the input text for punctuation prediction is provided. The input text is in a logographic language such as Chinese, and the input text does not include punctuations.

At procedure 1204, the punctuation prediction module 140 instructs the sub-character encoding module 122 to convert the text input into sub-character encoding, instructs the sentence piece generation module 124 to generate sentence pieces from the sub-character encoding, instructs the well-trained vector representation module 126 to retrieve corresponding vector representations of the generated sentences, and sends the vector representations to the well-trained neural network 136. In certain embodiments, when a novel character is present in the input text, and only one or a few sub-characters are recognizable from the novel character by the sub-character encoding module 122, the sub-character encoding module 122 may take the one or the few sub-characters as the representation of the whole novel character. For example, if a novel character has only one recognizable sub-character and the sub-character corresponds to an encoding, that encoding can be regarded as the encoding of the novel character.

At procedure 1206, upon receiving the vector representations of the input text, the well-trained neural network 136 predicts punctuations from the vector representations. In certain embodiments, when a sentence piece ends with a sub-character, the predicted punctuation for the sub-character may be placed after the character containing the sub-character.

In certain aspects, the present disclosure is related to applications relying on punctuation restoration. In certain embodiments, the applications include, for example semantic parsing, question answering, text summarization, subtitling, and machine translation.

In certain aspects, the present disclosure is related to a non-transitory computer readable medium storing computer executable code. The code, when executed at a processer 112 of the computing device 110, may perform the methods 1000, 1100 and 1200 as described above. In certain embodiments, the non-transitory computer readable medium may include, but not limited to, any physical or virtual storage media. In certain embodiments, the non-transitory computer readable medium may be implemented as the storage device 116 of the computing device 110 as shown in FIG. 1.

In summary, certain embodiments of the present disclosure, among other things, have the following beneficial advantages. First, the methods and system of the present disclosure consider the sub-character information that are unique for logographic languages such as Chinese, and the sub-character information is used to predict whether a punctuation mark exist after a character. By incorporating sub-character information of the character in the punctuation prediction model, the prediction accuracy is significantly improved. Second, the extraction of the sub-character is efficiently achieved by combining sub-character encoding with sentence piece generation. With the efficient extraction, the sub-character information attributes to the accurate punctuation prediction. Third, the number of sub-characters is small comparing to the number of characters. When a text for punctuation prediction includes an unknown or novel character, the novel character is likely to have one or a few recognizable sub-character components. Although the prediction model has no idea about the meaning of the novel character, it can still make reasonable punctuation prediction based on the sub-character components of the novel character. The methods and system thus perform well when novel character is encountered. Fourth, with fast moving trend in social media or fashion, new usages of a known character may be created. Without knowing the accurate meaning of the new usage, the method and system of the present disclosure can still make an accurate punctuation prediction based on the sub-characters of the character having the new usage.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for predicting punctuations for a text, comprising:
receiving the text, wherein the text is in a logographic language having a plurality of characters, at least one of the characters comprises a plurality of sub-characters representing meaning of the at least one character, and the text lacks punctuations;
providing, by a computing device, a sub-character encoding based on a sub-character input editor (IME), such that each character in the logographic language corresponds to a specific sub-character code;
encoding, by the computing device, the text using the sub-character encoding to obtain sub-character codes;
generating, by the computing device, sentence pieces from the sub-character codes;
representing, by the computing device, the sentence pieces by sentence piece vectors; and
subjecting, by the computing device, the vectors of the sentence pieces to a neural network to obtain the punctuations for the text.

2. The method of claim 1, wherein the language is Chinese, the characters are Chinese characters, and the IME is Wubi or Stroke.

3. The method of claim 1, wherein the step of generating the sentence pieces is performed using byte pair encoding.

4. The method of claim 1, wherein the step of representing the sentence pieces by vectors is performed using word2vec, and the word2vec has a model architecture of skip gram or continuous bag of words.

5. The method of claim 4, wherein word2vec is trained by:
providing a plurality of training text;
encoding the training text using the sub-character encoding to obtain training sub-character codes;
generating a vocabulary of sentence pieces from the sub-character codes based on a predefined sentence piece number; and
representing the vocabulary of sentence pieces by sentence piece vectors based on context of the training text.

6. The method of claim 5, wherein the language is Chinese, the number of the characters is in a range of 6,000 to 7,000, and the predefined sentence piece number is in a range of 20,000 to 100,000.

7. The method of claim 1, wherein the neural network is pretrained by:
providing a plurality of training text having punctuations;
encoding the training text using the sub-character encoding to obtain training sub-character codes;
generating training sentence pieces from the sub-character codes;
representing the training sentence pieces by sentence piece vectors;
labeling the training text using the punctuations to obtain punctuation labels;
generating predicted punctuation using the sentence piece vectors by the neural network; and
comparing the predicted punctuations with the punctuation labels to train the neural network.

8. The method of claim 1, wherein the neural network is a bidirectional long short-term memory (BiLSTM).

9. The method of claim 1, further comprising:
extracting the text from an e-commerce web site;
inserting the punctuations to the text to obtain text with punctuations; and
replacing the text with the text with punctuations on the e-commerce website.

10. The method of claim 1, further comprising:
extracting audio from a video;
processing the audio using audio speech recognition (ASR) to obtain the text;
inserting the punctuations to the text to obtain text with punctuations; and
adding the text with punctuations to the video.

11. A system for predicting punctuations for a text, wherein the system comprises a computing device, the computing device comprises a processor and a storage device storing computer executable code, and the computer executable code, when executed at the processor, is configured to:
receive the text, wherein the text is in a logographic language having a plurality of characters, at least one of the characters comprises a plurality of sub-characters representing meaning of the at least one character, and the text lacks punctuations;
provide a sub-character encoding based on a sub-character input editor (IME), such that each character in the logographic language corresponds to a specific sub-character code;
encode the text using the sub-character encoding to obtain sub-character codes;
generate sentence pieces from the sub-character codes;
represent the sentence pieces by sentence piece vectors; and
subject the sentence piece vectors to a neural network to obtain the punctuations for the text.

12. The system of claim 11, wherein the language is Chinese, the characters are Chinese characters, the IME is Wubi or Stroke, and the computer executable code is configured to:
generate the sentence pieces using byte pair encoding; and
represent the sentence pieces using word2vec.

13. The system of claim 12, wherein the word2vec is trained by:
providing a plurality of training text;
encoding the training text using the sub-character encoding to obtain training sub-character codes;
generating a vocabulary of sentence pieces from the training sub-character codes based on a predefined sentence piece number; and
representing the vocabulary of sentence pieces by sentence piece vectors based on context of the training text.

14. The system of claim 13, wherein the language is Chinese, the number of the characters is in a range of 6,000 to 7,000, and the predefined sentence piece number is in a range of 20,000 to 100,000.

15. The system of claim 11, wherein the neural network is pretrained by:
providing a plurality of training text having punctuations;
encoding the training text using the sub-character encoding to obtain training sub-character codes;
generating training sentence pieces from the training sub-character codes;
representing the training sentence pieces by sentence piece vectors;
labeling the training text using the punctuations to obtain punctuation labels;
generating predicted punctuation by the neural network using the sentence piece vectors; and
comparing the predicted punctuations with the punctuation labels to train the neural network.

16. The system of claim 15, wherein the neural network is a bidirectional long short-term memory (BiLSTM).

17. A non-transitory computer readable medium storing computer executable code, wherein the computer executable code, when executed at a processor of a computing device, is configured to:
receive a text, wherein the text is in a logographic language having a plurality of characters, at least one of the characters comprises a plurality of sub-characters representing meaning of the at least one character, and the text lacks punctuations;
provide a sub-character encoding based on a sub-character input editor (IME), such that each character in the logographic language corresponds to a specific sub-character code;
encode a text using the sub-characters encoding to obtain sub-character codes;
generate sentence pieces from the sub-character codes;
represent the sentence pieces by sentence piece vectors; and
subject the sentence piece vectors to a neural network to obtain punctuations for the text.

18. The non-transitory computer readable medium of claim 17, wherein the language is Chinese, the characters are Chinese characters, the neural network is a bidirectional long short-term memory (BiLSTM), and the computer executable code is configured to:
generate the sentence pieces using byte pair encoding; and
represent the sentence pieces using word2vec.

19. The non-transitory computer readable medium of claim 18, wherein the word2vec is trained by:
providing a plurality of training text;
encoding the training text by the sub-character encoding to obtain training sub-character codes;
generating a vocabulary of sentence pieces from the training sub-character codes based on a predefined sentence piece number; and
representing the vocabulary of sentence pieces by sentence piece vectors based on context of the training text.

20. The non-transitory computer readable medium of claim 18, wherein the neural network is pretrained by:
providing a plurality of training text having punctuations;
encoding the training text using the sub-character encoding to obtain training sub-character codes;
generating training sentence pieces from the training sub-character codes;
representing the training sentence pieces by sentence piece vectors;
labeling the training text using the punctuations to obtain punctuation labels;
generating predicted punctuation using the sentence piece vectors; and
comparing the predicted punctuations with the punctuation labels to train the neural network.
